(19) United States
(12) Patent Application Publication
(10) Pub. No.: US 2008/0109904 A1
(43) Pub. Date: May 8, 2008

(54) APPARATUS AND METHOD FOR MANAGING SECURE DATA

(75) Inventors: Ji-hyun IN, Seongnam-si (KR); Moon-sang Kwon, Seoul (KR); Song-ho Yoon, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/782,769

(22) Filed: Jul. 25, 2007

(30) Foreign Application Priority Data
Nov. 7, 2006 (KR) 2006-109495

(51) Int. Cl. G06F 11/00

(52) U.S. Cl. 726/22

(57) ABSTRACT

An apparatus, a method for use in the apparatus, for managing secure data stored in an OTP block. The apparatus includes a secure data recorder that records secure data and its complement, and records new secure data and its complement when a power outage occurs during recording, a secure data check unit that determines the validity of the secure data and its complement, and an error determiner that determines whether the recorded secure data is a partial recording of the new secure data if the secure data is invalid.

### CROSS-REFERENCE TO RELATED APPLICATION

This application is based on and claims priority from Korean Patent Application No. 10-2006-0109495, filed on Nov. 7, 2006 in the Korean Intellectual Property Office, the disclosure of which is incorporated herein in its entirety by reference.

### BACKGROUND OF THE INVENTION

1. Field of the Invention

Aspects of the present invention relate to a method and apparatus for managing secure data, and particularly to a method and apparatus for managing secure data stored in a one-time-programmable (OTP) block.

2. Description of the Related Art

Mobile devices, such as mobile phones, are no longer safe from viruses, worms, and attacks. In order to prevent program images from damage and change caused by the attacks, a defense mechanism involves detecting malware during boot and aborting the boot. As a method of detecting unauthorized change or damage, an electronic signature technique using a public key is widely used. That is, an authorized change or damage can be detected in the electronic signature by checking whether the stored program images and the electronic signature match. If an unauthorized user's signature exists or the signature does not match the stored program images, a hacker's attack is suspected.

In general, in order to safely protect program images stored in a flash memory, an electronic signature for of the program images is stored in a one-time-programmable (OTP) block of the flash memory. The OTP block cannot be modified (i.e., if the data is changed from 1 to 0, it cannot be changed back to 1). Therefore, a user must be careful when writing data to the OTP block. If the data has not been completely written to the OTP block due to a power failure, an unauthenticated electronic signature will exist in the OTP block.

Conventionally, to check the integrity of program images stored in a mobile device, the program images are stored with the electronic signature thereof. A digest is calculated using the stored program images while the mobile device is booted. The calculated digest is compared to the digest obtained after decoding of the stored electronic signature in order to see whether digests match. If the two digests do not match, it is considered that the stored program images have been damaged or changed by an unauthorized user, and the boot process is aborted.

In addition, if the unauthenticated digital signature has been written, a secure booting program aborts the boot process assuming an unauthorized user has damaged or changed the stored program images. A digital signature may become unauthenticated when power fails while the digital signature is being encrypted. In this case, the secure booting program considers that the program images have been damaged or modified. A digital signature that is incorrectly written to an OTP block cannot be modified due to the nature of the OTP block. If an unauthenticated digital signature is written on the OTP block, the OTP block can no longer be used, and thus the corresponding flash memory can no longer be used, which is a serious problem.

Therefore, there must be a way of disregarding a digital signature that became unauthenticated due to the power failure by distinguishing the unauthenticated digital signature from a digital signature that has been modified by a hacker. If a solution to the aforementioned problem is not found, every time the digital signature is incompletely written due to a power outage, the flash memory device will need to be replaced, which is a problem

Korean Unexamined Patent No. 2005-108637 (memory system safely loading main data and data loading method thereof discloses a memory system including a memory that stores main data and dummy data, and a controller. The controller that stores a copy of the dummy data, and loads the dummy data from the memory in power-up. The controller loads the main data when the loaded dummy data matches the reference data. However, Korean Patent No. 2005-108637 does not disclose a method of determining whether invalid secure data has been written to an OTP block due to a power outage.

### SUMMARY OF THE INVENTION

An aspect of the present invention provides a method of managing secure data of an OTP block.

According to an aspect of the present invention, there is provided an apparatus for managing secure data, the apparatus comprising a secure data recorder that records secure data and its complement, and records new secure data and its complement when a power outage occurs during recording, a secure data check unit that determines validity of the secure data and its complement, and an error determiner that determines whether the recorded secure data is a partial recording of the new secure data if the secure data is invalid.

According to another aspect of the present invention, there is provided a method of managing secure data, the method comprising determining the validity of secure data recorded on page 1 of the OTP block, finding valid secure data if the secure data is invalid, determining whether the secure data recorded on page 1 is a partial recording of the found valid, secure data, and determining that the secure data recorded on page 1 is modified due to a power outage if the secure data recorded on page 1 is the partial recording of the found valid, secure data.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features, aspects and advantages of the invention will become apparent and more readily by describing in detail embodiments thereof with reference to the accompanying drawings in which:

FIG. 1 illustrates an internal block diagram of a device that manages secure data according to an exemplary embodiment of the present invention;

FIGS. 2A and 2B illustrate internal configurations of a storage unit of a device that manages secure data according to an exemplary embodiment of the present invention;

FIG. 3 illustrates a process of determining what causes invalid secure data to be stored in a device that manages secure data according to an exemplary embodiment of the present invention;

FIG. 4 illustrates a process of determining what causes invalid secure data to be stored in a device that manages secure data according to an exemplary embodiment of the present invention;

FIG. 5 illustrates a table for checking for partial recording of secure data in an apparatus for managing secure data according to an exemplary embodiment of the present invention;

FIG. 6 is a flow chart illustrating a method of managing secure data by recording the secure data according to an exemplary embodiment of the present invention; and

FIG. 7 is a flow chart illustrating a method of managing secure data according to an exemplary embodiment of the present invention.

### DETAILED DESCRIPTION OF THE EMBODIMENTS

Reference will now be made in detail to the present embodiments of the present invention, exemplary embodiments of which will be described in detail with reference to the accompanying drawings. Advantages and features of the present invention and methods of accomplishing the same may be understood more readily by reference to the following detailed description of the exemplary embodiments and the accompanying drawings. Like reference numerals refer to like elements throughout the specification.

The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. The present invention is described hereinafter with reference to flowchart illustrations of user interfaces, methods, and/or computer program products according to embodiments of the invention, but is not limited the specific examples provided herein.

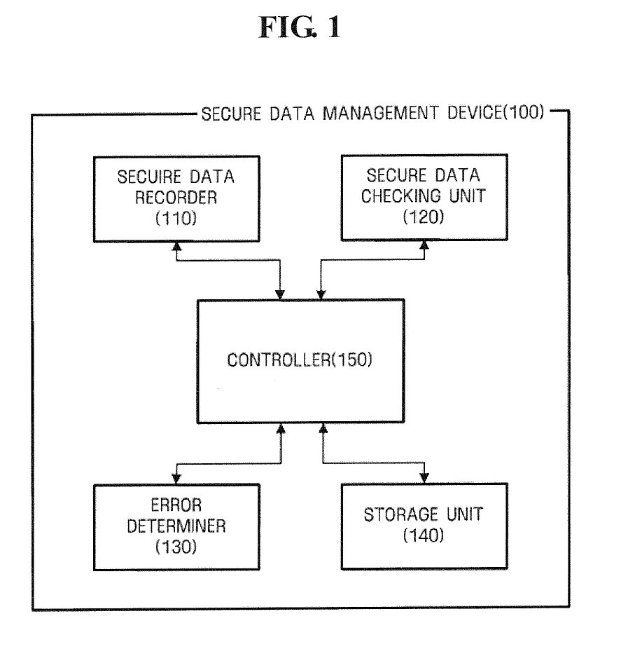

FIG. 1 illustrates an internal block diagram of a device that manages secure data according to an exemplary embodiment of the present invention. Referring to FIG. 1, a secure data-management device 100 includes a secure data recorder 111, a secure data-check unit120, an error determiner 130, a storage unit 140, and a controller 150. The controller 150 controls the operation of functional blocks 110-140 making up the secure data management device 100. While not required, it is understood that the device 100 can be included in a mobile device, such as a media player, telephone, or portable computer, or can be include in non-portable devices.

The term “module”, which generally refers to device 100 and can be, but is not limited to, a software or hardware component, such as a Field Programmable Gate Array (FPGA) or an Application Specific Integrated Circuit (ASIC), which executes certain tasks. A module may advantageously be configured to reside in the addressable storage medium, and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The secure data recorder 110 records secure data and its complement in a one-time-programmable (OTP) block of the storage unit 140. In the present example, the secure data is used to protect a predetermined program from damage or modification. An example of the secure data is an electronic signature, but is not limited thereto. In addition, if power is interrupted while the secure data and its complement are being recorded, the secure data recorder 110 records new secure data (i.e., valid secure data) and its complement in the storage unit 140. While shown as internal to the device 100, it is understood that the storage unit 140 can be detachable in other aspects.

In the shown embodiment, the secure data recorder 110 records the complement along with the secure data to determine the validity of the secure data. The complement is a data string that corresponds with the secure data through a predetermined relationship. For example, where the relationship is an inverse of the secure data, if the value of the secure data is “1101”, the complement is “0010”.

The secure data check unit 120 checks the stored secure data and its complement, which were recorded in the storage unit 140. The secure data check unit 120 determines the validity of the secure data by determining whether the secure data and its complement have the known relationship, which for the present example will be an inverse relationship. If the secure data and its complement do not have the inverse relationship, the secure data check unit 120 determines that the secure data stored in the storage 140 is invalid.

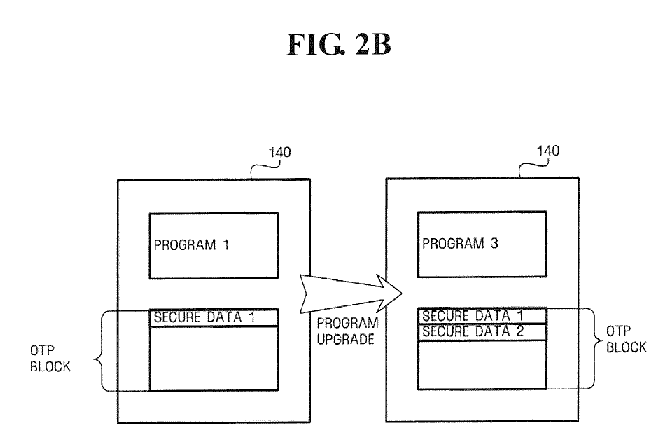

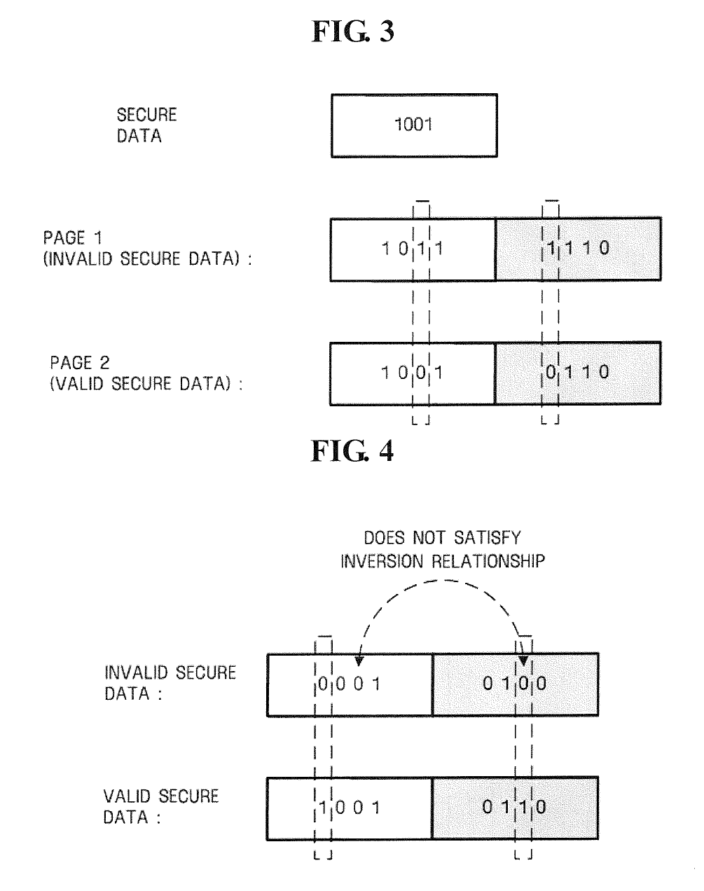

When the secure data check unit 120 determines that the secure data is invalid, the error determiner 130 determines whether recording of the invalid data is due to a non-hacking reason, such as a power outage, or due to a hacker compromising the program image. This determination can be performed by the error determiner 130 determining whether the invalid secure data recorded in the storage unit 140 is merely incompletely or partially recorded, valid, secure data. Hereinafter, a process of determining what causes invalid secure data to be recorded will be described in detail below with reference to FIGS. 3 and 4.

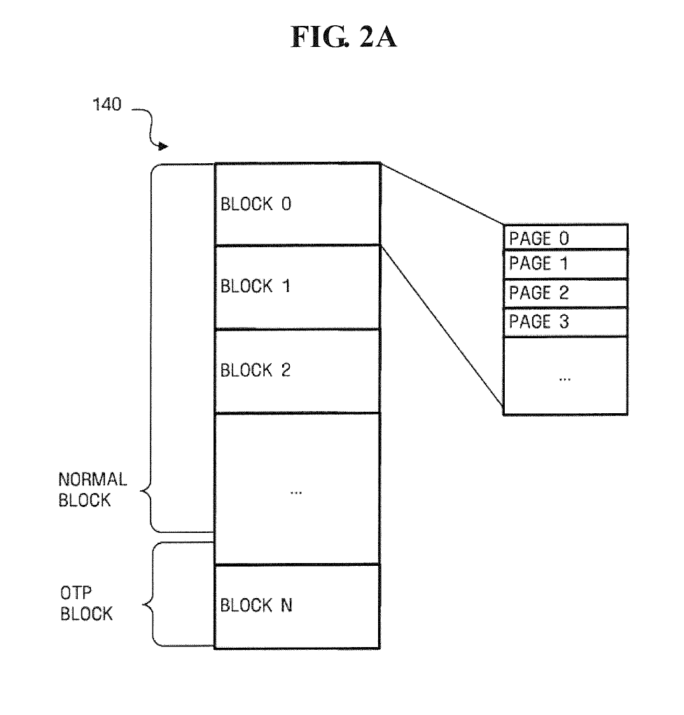

The storage unit 140 stores the secure data and its complement. Here, the storage unit 140 may store one or more sets of secure data and their complements. Hereinafter, examples of configurations of the storage unit 140 will be described in detail with reference to FIGS. 2A and 2B. Here, while the storage unit 140 is described in terms of a flash memory by way of example, it is understood that other forms of memory can be used, including magnetic and/or optical media.

Referring to FIG. 2A, the storage unit 140 includes a plurality of blocks 0, 1, 2, N. By way of example, the block can be the unit of a delete operation of the flash memory, and contains a plurality of pages 0, 1, 2, 3. The page is the unit of a read/write operation of the flash memory. Additionally, the block is classified into erasable blocks (normal blocks 0, 1, 2) and unerasable blocks (OTP blocks N). The normal blocks 0, 1, 2, can carry out the read, write, and delete operations (i.e., are rewritable). Conversely, the OTP blocks N are unerasable, and are characterized in that data cannot be modified once written (i.e., the OTP blocks are write-once). The normal blocks can include program images, audio data, video data, or other data, the security for which is implemented using the secure data of the OTP blocks N. However, it is understood that ones of the normal blocks 0, 1, 2 need not always be rewritable, and can be write protected to prevent accidental erasure of program images or other data written thereto.

For the flash memory example, the flash memory has an initial value of “1,” but is changeable to a value of “0” via the write operation. In order to modify the value from “0” to “1”, the entire block should be initialized to “1” via the delete operation in block units. Namely, once the value is recorded as “0”, it cannot be modified to “1” unless initialized via the delete operation.

The flash memory carries out a program per page, and the data is recorded in units of bits. Therefore, once a specific bit in the OTP block N has been programmed from “1” to “0”, it cannot be modified back to “1” since the corresponding block cannot be erased. The OTP blocks N are unerasable, and thus are used to store data that must be safely protected for a security check such as secure data (such as an electronic signature). While described in terms of an electronic signature, it is understood that the secure data can also include Digital Rights Management, license info, or other information used in a security check.

Referring to FIG. 2B, a program 1 is stored in a predetermined block of the storage unit 140 for program security and secure data 1 (e.g., an electronic signature 1) is stored in an OTP block of the storage unit 140. When the predetermined program 1 is updated, the new program 3 and secure data 2 with regard thereto are updated. In this case, since the secure data is stored in the OTP block, which is unerasable, the new secure data 2 is recorded by searching for pages (or sectors) that are not being used in the OTP block. As shown, the secure data 2 is sequentially recorded on the empty pages in the OTP block after the old secure data 1 in order to easily search for valid and up-to-date, secure data. However, it is understood that the secure data can be otherwise located in the OTP block.

FIG. 3 illustrates a process of determining what causes invalid, secure data to be stored in the device 100. Here is an example in which the recording of the secure data is not completed due to a power outage (i.e., a non-hacking event). While described in terms of a power outage, it is understood that other non-hacking events can cause similar interruptions while recording the secure data and its complement. By way of example, the recording may be interrupted by a battery losing power, a loss of signal during transmission, an emergency shutdown of the apparatus, the device “freezing” due to a program irregularity, etc.

If secure data is recorded by the secure data recorder 110 along with its complement in the OTP block of the storage unit 140, the error determiner 130 can determine whether the power failed while the secure data was being recorded as distinguished from whether the secure data was illegally modified by a hacker. That is, the validity of the secure data can be determined by recording a predetermined secure data along with its complement, and checking whether the secure data and its complement have an inverted relationship by comparing the secure data to its complement. If the secure data is invalid, it should be determined whether the invalidity was caused by a power outage or a hacker. Hereinafter, an example of incomplete recording of the secure data due to the power outage will be described.

As illustrated in FIG. 3, if only some pieces of bits of the secure data (e.g., an electronic signature) are recorded due to the power outage during an update, a developer or a service center again sends the secure data and the secure data recorder 110 records the newly-sent secure data and its complement on the next page or sector of the OTP block of the storage unit 140.

Because the invalid secure data is the data that has been incompletely recorded, if the N^{th} offset bit is “1” in the secure data recorded on the next page, the N^{th} offset bit of the invalid secure data must be “1” at all times. If this rule (hereinafter, referred to as the “offset rule”) does not apply to any one of the bits, it is considered that the secure data has been modified by a hacker.

For the shown example in FIG. 3, the secure data “1001” is supposed to be recorded on page 1 of the OTP block. However, “1011/1110” is instead recorded due to the power outage. The again sent valid, secure data “1001/0110”, which was originally supposed to be recorded, is recorded on the next page (i.e., page 2) of the OTP block. Then, the secure data-check unit 120 checks whether the secure data stored in page 1 of the OTP block is valid. If the secure data is invalid, the secure data-check unit 120 checks the secure data stored in page 2 for validity.

Next, the error determiner 130 compares the N^{th} offset bit of the invalid secure data on page 1 with the N^{th} offset bit of the secure data on page 2, where N is an integer equal to or greater than one. If the offset rule is satisfied (i.e., the invalid secure data is the valid secure data that has been partially recorded), it is determined that the invalid secure data is recorded on page 1 due to the power outage, and it is checked whether the secure data stored in page 2 is valid (i.e. a complement).

As shown in FIG. 3, for the secure data, the third bit does not match the invalid secure data stored in the OTP block. Thus, the N^{th} offset bit is the third bit and, for the invalid secure data, is 1; while the N^{th} offset bit of the stored valid secure data is 0. Further, the N^{th} offset bit of the invalid complement to the secure data is the first bit, which is 1, while the N^{th} offset bit of the valid complement to the secure data is 0. As such, the N^{th} bit is any of the secure data bits being checked, with the highlighted bits in FIG. 3 indicating those bits which do not correspond to the valid secure data and its complement.

FIG. 4 illustrates a process of determining what causes invalid secure data to be stored in the device 100. It is understood that the following details are an example in which valid secure data is modified by a hacker.

When the hacker damages the secure data stored in an unerasable block, such as an OTP block, the hacker can modify some of the data recorded as “1” to “0”, but cannot modify the data recorded as “0” to “1”. If the secure data is recorded with its complement, the complement that has been recorded as “0” cannot be modified. Therefore, the secure data modified by the hacker and its complement do not satisfy an inverse relationship.

That is, a hacker may modify the first bit of the secure data from “1” to “0”, but cannot modify the first bit of the complement of the secure data to “1” because it is recorded in the OTP block. Hence, the type of invalid secure data may be found by checking whether the inverse relationship is satisfied.

As illustrated in FIG. 4, when the valid secure data is modified by the hacker, the inverse relationship is not satisfied. For example, if a hacker modifies the first bit “1” of valid secure data “1001” to “0” in order to make “0001”, and modifies the third bit “1” of the complement of the valid secure data “0110” to “0” in order to make “0100”, the secure data and its complement do not satisfy the inverse relationship.

In addition, if the inverted relationship is not satisfied and the invalid secure data as a result of the power outage must be the partial recording of the valid data recorded on the next page. However, if “0” is recorded in the invalid secure data such as the first offset bit, but “1” is recorded in the valid, secure data, the invalid secure data cannot be the partial recording of the valid secure data and it is considered that the power outage is not the cause of the invalid secure data and the invalidity is due to a compromise of the secure data.

Therefore, it can be determined whether an electronic signature or other secure data has been incompletely recorded, or was instead modified such as by the hacker by comparing the invalid secure data that does not satisfy the inverted relationship because of an unexpected power outage to the valid secure data recorded on the next page and checking whether the invalid secure data is a partial recording of the valid secure data.

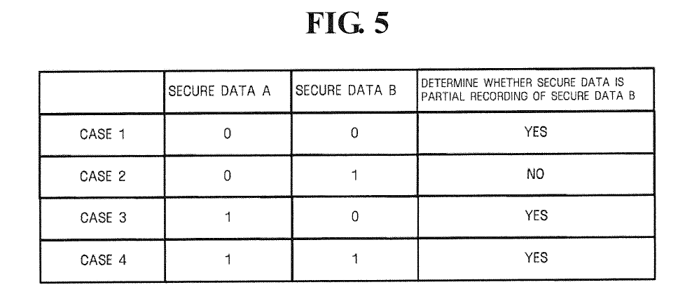

FIG. 5 illustrates a table checking for partial recording of secure data in an apparatus for managing the secure data according to an exemplary embodiment of the present invention. In order to rapidly check whether invalid secure data is the partial recording of valid secure data in the next page, an XOR operation may be used.

Referring to the table, of all four cases that each bit of secure data A and secure data B can have, case 2 is the only case where the secure data A is “0” and the secure data B is “1” and thus the secured data A cannot be the partial recording of the secure data B. That is, if there is a power outage while “0” is being recorded, “0 or “1” is recorded depending on the case. Accordingly, the partial recording of “0” is “0” or “1”. Conversely, if there is the power outage while “1” is being recorded, the partial recording of “1” is 1”.

In order to rapidly check whether the secure data A is the partial recording of the secure data B using the aforementioned algorithm, an XOR operation is performed between two secure data A and B and an AND operation is performed between the result of the X-OR operation and the valid secure data B (i.e., A XOR B AND B). If the result of the operation is “0”, it is determined that the secure data A is the partial recording of the secure data B. While not required in all aspects, the XOR operation is can be performed between two secure data complements A and B and an AND operation is performed between the result of the X-OR operation and the valid secure data complements B (i.e., A XOR B AND B). If the result of the operation is “0”, it is determined that the secure data A is the partial recording of the secure data B. As such, the XOR operation can be performed on the secure data, the secure data complement, or combinations thereof.

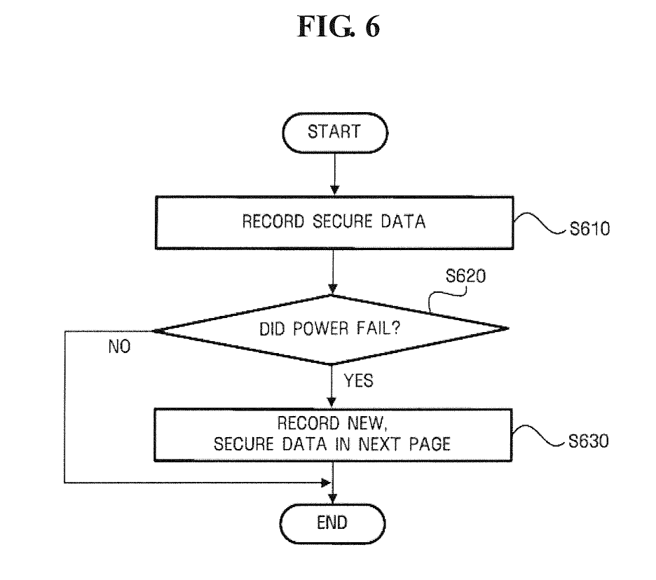

FIG. 6 is a flow chart illustrating a method of managing secure data by recording the secure data according to an exemplary embodiment of the present invention. The secure data recorder 110 records secure data and its complement in an OTP block of a storage unit 140 S610. Here, the secure data is used to protect a predetermined program from damage or unauthorized modification, and is, for example, an electronic signature.

If a power outage does not occur while the secure data and its complement are being recorded S620 the secure data and its complement are recorded in the storage unit 140. Conversely, if the power outage occurs while the secure data and its complement are being recorded S620, the secure data recorder 110 records new secure data and its complement in another page S630. Here, the new secure data is recorded on the next page of the OTP block that recorded the secure data. In addition, the new secure data and its complement should be recorded because it is likely that the secure data and its complement were recorded as invalid secure data due to an unexpected power outage. Thus, valid secure data should be recorded, and the error determiner 130 determines whether the invalid data was recorded due to a power outage, or due to a hacker by recording the new secure data and its complement. The power outage may occur while the new secure data and its complement are being recorded. In this case, S620 and S630 are repeated.

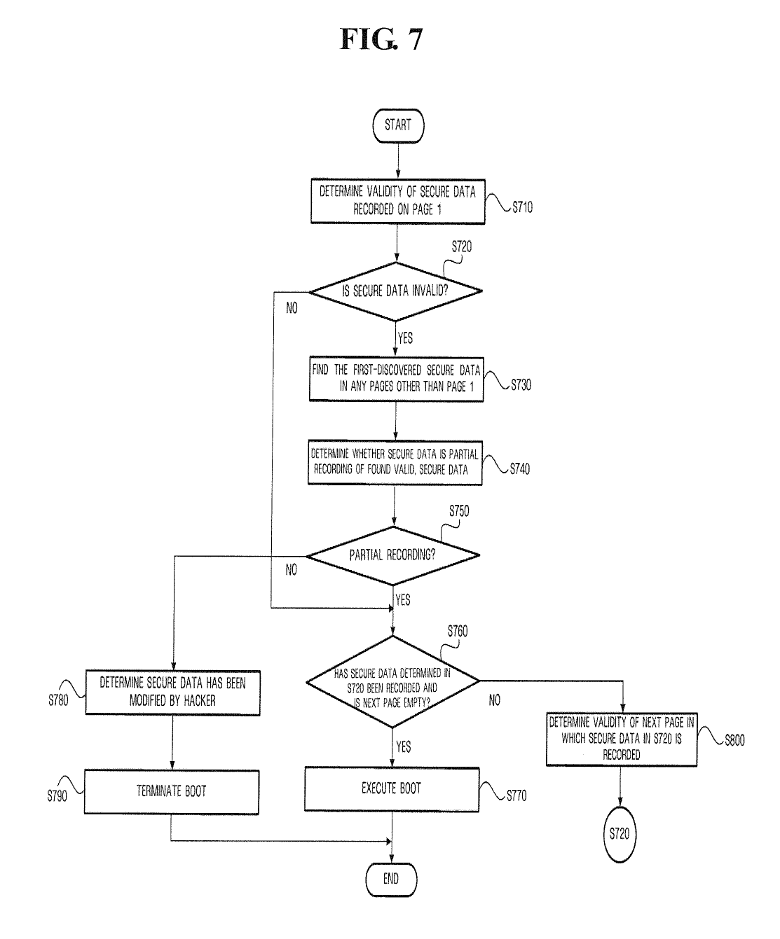

FIG. 7 is a flow chart illustrating a method of managing secure data according to an exemplary embodiment of the present invention. Here, whether a predetermined device is booted or not is determined by determining the validity of the secure data. The secure data-check unit 120 determines the validity of secure data recorded on page 1 of an OTP block of a storage unit 140 S710. Here, the validity can be determined by determining whether the secure data and its complement are proper.

If the secure data recorded on page 1 is valid S720, a boot process is executed in S770 assuming the next page is empty in S760. However, if the secure data is invalid S720, the error determiner 130 checks whether the valid, secure data exists S730. Here, the valid secure data may be recorded on a predetermined page of the OTP block.

Then, the N^{th} offset bit of the secure data on page 1 and that of the found valid secure data are compared in order to determine the secure data on page 1 is partial recording of the valid secure data S740. Here, since a determining process has been described with reference to FIGS. 3 through 5, a detailed description thereof will be omitted.

When the secure data on page 1 is not a partial recording of the valid secure data S750 as a result of S740, the error determiner 130 determines that the secure data on page 1 has been modified by a hacker S780, and a boot process is terminated S790. Conversely, if the secure data on page 1 is the partial recording of the valid secure data S750, the controller 150 checks whether the valid secure data is recorded on the next page (e.g., page 2) and the following page is an empty page. Here, the empty page refers to a page without predetermined data (e.g., the secure data). When the corresponding page (e.g., page 3) is empty as a result of S760, even though an invalid page has previously been found, it is determined that the invalid secure data has been recorded due to a power outage and the boot process is executed S770.

If the corresponding page is not empty as the result of S760, the validity of the secure data recorded on the corresponding page is determined S800. Then, S720-S790 are repeated.

As described above, according to a method and apparatus for managing secure data, the following effect, among other effects, can be anticipated. When invalid data is recorded on in an OTP block, a security check is efficiently and safely performed, and a device does not have to be replaced by determining whether a power outage or a hacker is responsible for the recording of the invalid data.

While described in the context of mobile devices, such as telephones, cameras, personal digital assistants, or media players, it is understood that aspects of the invention can be implemented in portable and non-portable computers.

The exemplary embodiments of the present invention have been explained with reference to the accompanying drawings, but it will be apparent to those skilled in the art that various modifications and changes may be made thereto without departing from the scope and spirit of the invention as defined in the accompanying claims or equivalents thereof. Therefore, it should be understood that the above embodiments are not restrictive but illustrative in all aspects.

What is claimed is:

1. An apparatus for managing secure data, the apparatus comprising:
a secure data recorder that records secure data and a secure data complement, and records new secure data and a new secure data complement when a power outage occurs during recording of the secure data and the secure data complement;
a secure-data-check unit that determines a validity of the secure data and the secure data complement; and
an error determiner that detects that the recorded secure data, which the secure data check unit determines is invalid, is a partial recording of the new secure data as distinguished from invalidity due to unauthorized modification of the secure data.

2. The apparatus of claim 1, wherein if the recorded secure data is the partial recording of the new secure data, the error determiner determines that the secure data has been modified by a power outage.

3. The apparatus of claim 1, wherein if the recorded secure data is not the partial recording of the new secure data, error determiner determines that the secure data is modified by a hacker.

4. The apparatus of claim 1, further comprising: a storage unit that stores the secure data and the secure data complement.

5. The apparatus of claim 4, wherein the storage unit is includes a one-time-programmable (OTP) block to store the secure data and the secure data complement.

6. A method of managing secure data, the method comprising:
determining the validity of secure data recorded on page 1 of a one-time-programmable (OTP) block;
finding valid other secure data if the secure data is invalid;
determining whether the secure data recorded on page 1 is a partial recording of the found valid other secure data; and
detecting that the secure data recorded on page 1 was changed from the valid other secure data due to a power outage when the secure data recorded on page 1 is the partial recording of the found valid secure data as distinguished from invalidity due to unauthorized modification of the secure data.

7. The method of claim 6, wherein the valid secure data is recorded on page 2.

8. The method of claim 7, wherein the secure data and a complement of the secure data are recorded on page 1 and the valid other secure data and a complement of the valid other secure data is recorded on page 2.

9. The method of claim 7, wherein the valid other secure data and a complement of the valid other secure data are recorded after a power outage occurs while recording the secure data and a complement of the secure data on page 1.

10. The method of claim 6, further comprising determining that the secure data was modified by a hacker if the secure data recorded on page 1 is not a partial recording of the found other valid, secure data.

11. The method of claim 6, wherein the determining the validity comprises comparing the secure data and a complement of the secure data to determine if the complement and the secure data have an inverse relationship.

12. The method of claim 6, further comprising detecting that the secure data recorded on page 1 was changed from the valid other secure data due to a security compromise when the secure data recorded on page 1 is not the partial recording of the found valid secure data, and preventing access to recorded data related to the secure data when the detecting that the secure data is invalid due to the security compromise.

13. The apparatus of claim 1, wherein the secure data check unit determines that the secure data is valid when the secure data has inverse values of the secure data complement, and determines that the secure data is invalid when the secure data does not have inverse values of the secure data complement.

14. An apparatus for managing secure data indicating whether recorded data has been compromised, the apparatus comprising:
a secure data validity checker which records secure data and a secure data complement and, where the secure data and the secure data complement do not satisfy a predetermined relationship such that the secure data is invalid, records new secure data and a new secure data complement; and
an error determiner that, for each error in the predetermined relationship between the secure data and the secure data complement, uses another relationship between the new secure data, the new secure data complement, the secure data, the secure data complement, or combinations thereof to distinguish between a first error indicating a security compromise of the secure data and a second error not due to the compromise of the secure data but which is due to the secure data being incompletely written.

15. The apparatus of claim 14, further comprising a controller which allows the use of the recorded data when the secure data is found valid, allows the use of the recorded data when the secure data is found invalid but the determined error is the second error, and prevents the use of the recorded data when the secure data is found invalid but the determined error is the first error.

16. The apparatus of claim 14, further comprising a memory having one or more rewriteable blocks and one or more write once blocks, wherein the recorded data is recorded in the rewritable blocks, the secure data and the secure data complement are written in a first portion of the one or more write once blocks, and the new secure data and the new secure data complement are written in a second portion of the one or more write once blocks other than the first portion.

17. The apparatus of claim 16, wherein the memory comprises a flash memory, and the one or more write once blocks comprise a one-time-programmable block.

18. The apparatus of claim 14, wherein the predetermined relationship is an inverse relationship in which corresponding bits of the secure data and the secure data complement have opposite values, and the invalid secure data is the secure data which does not have the inverse relationship between corresponding bits of the secure data and the secure data complement.

19. The apparatus of claim 18, wherein the another relationship is one in which corresponding bits of the invalid secure data and the new secure data have opposite values which can only occur due to the compromise or the invalid secure data complement and the new secure data complement have opposite values which can only occur due to the compromise.

20. The apparatus of claim 19, further comprising a memory having one or more rewriteable blocks and one or more write once blocks, wherein the recorded data is recorded in the rewritable blocks, the secure data and the secure data complement are written in a first portion of the one or more write once blocks, and the new secure data and the new secure data complement are written in a second portion of the one or more write once blocks other than the first portion.

21. The apparatus of claim 14, wherein the error determiner performs an XOR operation between the secure data and the new secure data to generate an XOR result, performs an AND operation on the XOR result and the new secure data to generate an XORAND result, and determines that the error is the second error if the XORAND result is “0”.

22. The apparatus of claim 20, wherein the error determiner performs an XOR operation between the secure data complement and the new secure data complement to generate an XOR result, and performs an AND operation on the XOR result and the new secure data complement to generate an XORAND result, and the error determiner determines that the error is the second error if the XORAND result is “0”.

23. The apparatus of claim 22, further comprising a controller which allows the use of the recorded data when the secure data is found valid or when the secure data is found invalid but the determined error is the second error, and prevents the use of the recorded data when the secure data is found invalid but the determined error is the first error.

24. A method for managing secure data indicating whether recorded data has been compromised, the method comprising:
obtaining new secure data and a new secure data complement since the secure data is determined to be invalid as the secure data and a secure data complement do not satisfy a predetermined relationship; and
determining an error type for the invalid secure data by comparing the secure data, the secure data complement, the new secure data, the new secure data complement, or combinations thereof to detect a presence of another relationship,
wherein:
if the another relationship is detected, the error type is determined to be a first error indicating a compromise of the secure data such that the recorded data is not usable; and
if the another relationship is not detected, the error type is determined to be a second error not due to the compromise of the secure data but which is due to the secure data being incompletely written such that the recorded data is usable.

25. The method of claim 24, wherein the recorded data is recorded in one or more rewritable blocks of a memory, the secure data and the secure data complement are recorded in a first portion of one or more write once blocks of the memory, and the obtaining the new secure data and the new secure data complement comprises retrieving the new secure data and the new secure data complement from a second portion of the one or more write once blocks other than the first portion.

26. The method of claim 25, wherein the memory comprises a flash memory, and the one or more write once blocks comprise a one-time-programmable (OTP) block.

27. The method of claim 24, wherein the predetermined relationship is an inverse relationship in which corresponding bits of the secure data and the secure data complement have opposite values, and the invalid secure data is the secure data which does not have the inverse relationship between corresponding bits of the secure data and the secure data complement.

28. The method of claim 27, wherein the another relationship is one in which corresponding bits of the invalid secure data and the new secure data have opposite values which can only occur due to the compromise or the invalid secure data complement and the new secure data complement have opposite values which can only occur due to the compromise.

29. The method of claim 24, wherein the determining the error type comprises:
performing an XOR operation between the secure data and the new secure data to generate an XOR result,
performing an AND operation on the XOR result and the new secure data to generate an XORAND result, and
determining that the error is the second error if the XORAND result is “0”.

30. The method of claim 24, wherein the determining the error type comprising:
performing an XOR operation between the secure data complement and the new secure data complement to generate an XOR result,
performing an AND operation on the XOR result and the new secure data complement to generate an XORAND result, and
determining that the error is the second error if the XORAND result is “0”.

31. The method of claim 24, further comprising:
allowing a boot up operation to access the recorded data when the secure data is found valid or when the secure data is found invalid but the determined error is the second error, and
preventing the boot up operation to prevent the use of the recorded data when the secure data is found invalid but the determined error is the first error.

32. A computer readable medium encoded with processing instructions for implementing the method of claim 24 using one or more computers.
